(19) United States
(12) Patent Application Publication
(10) Pub. No.: US 2016/0267911 A1
(43) Pub. Date: Sep. 15, 2016

(54) VEHICLE VOICE ACQUISITION SYSTEM WITH MICROPHONE AND OPTICAL SENSOR

(71) Applicant: MAGNA MIRRORS OF AMERICA, INC., Holland, MI (US)

(72) Inventor: Christopher R. Koetje, Zeeland, MI (US)

(21) Appl. No.: 15/067,492

(22) Filed: Mar. 11, 2016

Related U.S. Application Data
(60) Provisional application No. 62/132,818, filed on Mar. 13, 2015.

(51) Int. Cl. G10L 15/22; G10L 15/25; H04R 1/02; B60R 1/00

(52) U.S. Cl. CPC G10L 15/22; B60R 1/00; G10L 15/25; H04R 1/028; B60R 2300/8006; G10L 2015/223; H04R 2499/13

(57) ABSTRACT

A voice acquisition system for a vehicle includes an optical sensor disposed at an interior portion of the vehicle and having a sensing field that encompasses a driver's head region in the vehicle cabin typically occupied by a driver's head. An optical sensor processor is provided for processing an output of the optical sensor to determine optically-derived vocal signals emanating from the driver. A microphone is provided and is operable to receive audible signals from in the vehicle cabin. A microphone processor is provided for processing an output of the microphone to determine audio-derived vocal signals emanating from the driver. A control, responsive to processing of the output of the optical sensor by the optical sensor processor and processing of the output of the microphone by the microphone processor, isolates the driver's voice from other acoustic noise.

### CROSS REFERENCE TO RELATED APPLICATION

The present application claims the filing benefits of U.S. provisional application Ser. No. 62/132,818, filed Mar. 13, 2015, which is hereby incorporated herein by reference in its entirety.

### FIELD OF THE INVENTION

The present invention relates generally to the field of voice acquisition and recognition systems for vehicles.

### BACKGROUND OF THE INVENTION

It is known to provide a microphone in a vehicle to receive audible voice signals from within the vehicle, such as for a telematics system or the like.

### SUMMARY OF THE INVENTION

The present invention provides a voice acquisition system that includes at least one microphone disposed in a vehicle cabin and at least one optical sensor disposed at an interior portion of the vehicle, such as at an interior rearview mirror assembly of the vehicle. The microphone receives audible signals, such as vocal signals from the driver of the vehicle and the optical sensor is aimed at the region where the driver's head and mouth or neck or throat is typically located. The system processes the audio signals from the microphone and processes data (such as image data) captured by the optical sensor (such as a camera or interferometer) to provide enhanced voice acquisition and recognition. The optical sensor processor processes an output of the optical sensor to determine vibrations of the driver that are indicative of vocal signals emanating from the driver. The system may operate in conjunction with an infotainment system or telematics system or navigation system of the vehicle, whereby the recognized voice statements or commands are used as inputs for the associated infotainment system or telematics system or navigation system of the vehicle.

The processing of captured optical sensor data provides a very reliable signal which only contains voice information. Other acoustic noises in the vehicle cabin are not detected by the optical sensor. However, the optical sensor does not typically have enough signal bandwidth by itself for optimum voice acquisition. Enhanced acquisition of voice signals from the vehicle occupants is possible by the combination of the acoustic microphone and optical sensor signals. The enhanced voice acquisition may be used for enhanced control of or input to the associated infotainment system or telematics system or navigation system of the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly having an optical sensor disposed thereat in accordance with the present invention, shown with the field of view of the optical sensor encompassing the mouth of the driver;

FIG. 2 is a perspective view of another interior rearview mirror assembly having an optical sensor disposed thereat in accordance with the present invention; and

FIG. 3 is a perspective view of another interior rearview mirror assembly having an optical sensor disposed thereat in accordance with the present invention, shown with the optical sensor disposed behind the reflective element and viewing through the reflective element.

### DESCRIPTION OF THE PREFERRED EMBODIMENTS

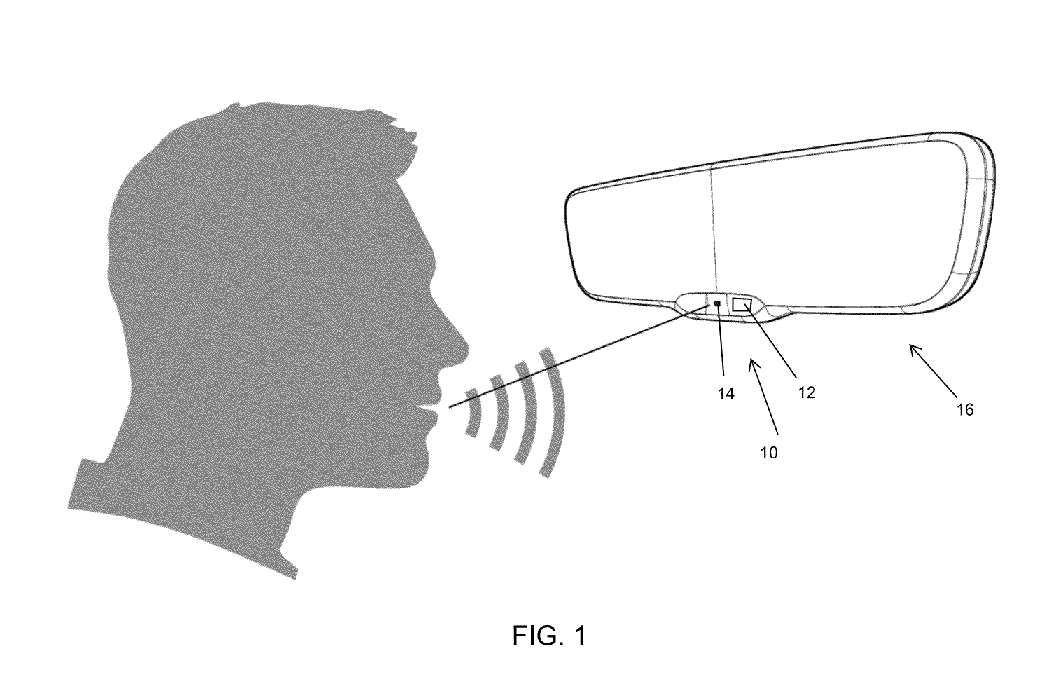

Referring now to the drawings and the illustrative embodiments depicted therein, a voice acquisition system or sound processing system 10 of the vehicle includes one or more microphones 12 and one or more optical sensors 14 (such as an interferometer), such as at an interior rearview mirror assembly 16 of a vehicle (FIG. 1). In the illustrated embodiment, the mirror assembly 16 includes one or more optical sensors 14 that has a field of view or scanning area that encompasses a region where the neck and face of a driver is typically located. The optical sensor captures data representative of vibration due to the voice or audio signal generated by the driver and a processor processes captured optical data to determine movement of the driver's mouth or vibration at the driver's mouth or neck or throat of the like or to otherwise provide optical detection of the driver's voice. The processing of captured optical data is used to enhance acquisition and recognition of vocal signals received by the microphone and processed by a sound processor of the voice acquisition system. Thus, the use of the optical sensor in conjunction with the microphone and sound processor provides enhanced acquisition and recognition of vocal signals or commands made by the driver of the vehicle, such as for use with an associated infotainment system or telematics system or navigation system of the vehicle, as discussed below.

The system of the present invention combines or integrates an optical sensor and processor with an acoustic microphone, which provides a significant increase in voice acquisition and recognition and voice intelligibility. The system may utilize aspects of the systems described in U.S. Pat. Nos. 8,442,820; 8,286,493; 7,775,113; 7,657,052; 6,243,003; 6,278,377 and/or 6,420,975, which are hereby incorporated herein by reference in their entireties. The system may comprise a camera that captures image data of the driver's mouth (such as via a field of view that encompasses the driver's head or area surrounding the driver's head), with an image processor processing captured image data to read the lips of the driver. Optionally, and preferably, the optical sensor may comprise an interferometer or a laser sensor that generates or points laser beams or electromagnetic waves or beams and analyzes the physical properties of the beams as reflected or altered from a vibration generating sound source (the driver's face and/or mouth and/or throat) to reconstruct the vocal signal generated by the sound source. Optionally, the optical sensor may comprise a LIDAR sensor, preferably a 3D LIDAR sensor. The optical sensor is operable to remotely detect vibration at a micron scale to detect or determine the voice of the driver.

The optical sensor for the system of the present invention preferably comprises an interferometer that senses the laser light that reflects from the targeted region. The optical sensor processor processes outputs of the optical sensor to determine the vibration of the driver's mouth or face or neck or throat. The laser beam (such as an infrared laser or near-infrared laser or visible laser) is modulated to limit or avoid any issues that may arise due to the ambient lighting (such as sunlight) at the vehicle cabin and/or mirror assembly. The laser light source includes an optical lens and/or a small spot size at the target area (such as less than about 20 mm, preferably less than about 10 mm, such as in the range of about 2.5 mm to about 10 mm or thereabouts). If the spot size is too large, this will introduce noise to the sensor, and if the spot size is too small, the signal received by the sensor will be reduced. The sensor and laser may comprise co-axial devices (whereby the sensor and laser both originate at the same point) or may be focused from different, separate locations (such as different parts of the mirror assembly). The optical sensor thus measures the vibrations at the driver's face and neck and is not receptive to other acoustic noises which may degrade the signal. This is because the optical sensor only receives vibrations generated by the person that is speaking, who is targeted by the laser. Optionally, a camera (and image processor that processes image data captured by the camera), having a field of view that encompasses the face region of the driver of the vehicle, may be used to assist in aiming the laser source and/or interferometer sensor.

The present invention provides one or more optical sensors at an interior portion of the vehicle, such as at the interior rearview mirror assembly. The optical sensor has a limited sensing region that measures vibration at the target location (which may be any suitable area of the driver's head or mouth or neck where a vibration signal may be detected that is indicative of the driver speaking), and optionally multiple sensors may be provided for coverage of a passenger or passengers in the passenger seat or seats (in addition to or instead of the driver). The face and neck region of the driver or passenger offers several areas of equal vibration signals that are indicative of the person speaking. Thus, the available sensing field for the sensor may encompass the entire face and neck region of the driver (and/or passenger), but the sensor may focus on a particular target region or regions of the driver's (and/or passenger's) face and neck. Optionally, a single optical sensor may be provided with multiple beams to spread or expand the sensing area.

The optical sensor and processor are paired with a directional or omni-directional acoustic microphone. Such omni-directional microphones may be lower cost and may be provided in a smaller package size. Optionally, and desirably, the microphone or microphones are disposed at or in the mirror assembly (such as by utilizing aspects of the systems described in U.S. Pat. No. 7,657,052, incorporated above). Optionally, the acoustic microphone or microphones may be external to the mirror assembly and disposed elsewhere within the vehicle cabin.

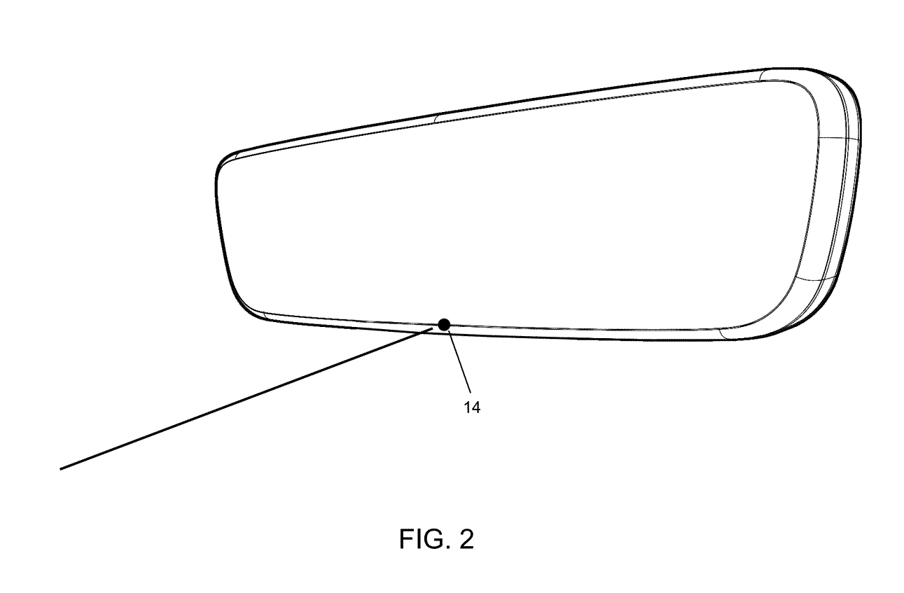

As shown in FIG. 1, the optical sensor may be disposed at a bezel portion or housing portion of the mirror assembly, where the sensor is disposed within the bezel and views through an aperture in the bezel. In the illustrated embodiment, the optical sensor is disposed below the reflective element (at a chin portion of the bezel or mirror casing), but could be disposed above the reflective element or elsewhere around the reflective element. The optical sensor (and optionally the microphone as well) may be disposed at an enlarged sensor support portion of the bezel (such as shown in FIG. 1), or the optical sensor may be hidden along the bezel portion (such as shown in FIG. 2).

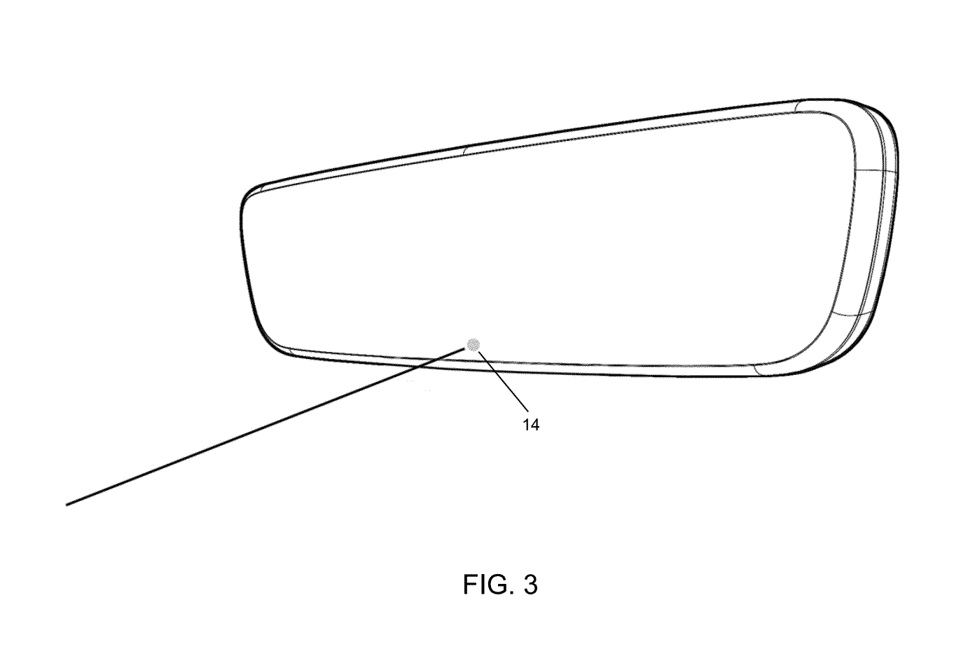

Optionally, the optical sensor may be disposed behind the reflective element so as to view through the reflective element (such as shown in FIG. 3). The reflective element mirror reflector and/or ITO coating at the mirror substrate or substrates may be reduced at the area in front of the sensor to enhance or maximize IR transmission through the reflective element or mirror substrate. The system may utilize amplified laser power output and may provide control of an external laser.

The microphone receives the vocal or audio signal and generates an analog signal output to a processor or control. A digital audio signal connection to the processor or control may be provided, such as via A2B, I2S, LVDS, MOST, flex-ray, IRDA and/or the like.

The system may utilize a noise reduction algorithm and processing. Such processing may be provided within the mirror so a “clean” audio signal is provided to a vehicle control or system. Optionally, the processing may be provided external to the mirror, where the mirror assembly provides the location for both the acoustic microphone and the optical sensor or optical microphone, with the processing of outputs of the microphone and sensor being remote from the mirror.

Thus, the present invention provides a voice acquisition system having an optical sensor at an interior rearview mirror assembly of a vehicle, where the optical sensor is used to determine vocal signals emanating from the driver (and/or passenger) of the vehicle. The system processes outputs of the optical sensor to determine vibration and thus the spoken words or commands, such as for use in connection with another vehicle system. By virtue of the optical sensor's targeted sensing field, the signal from the optical sensor is indicative only of the voice signal from the targeted driver (or targeted passenger). The system also includes an acoustic microphone for detecting the audible signals, whereby sound processing of outputs of the acoustic microphone also determine the vocal signals emanating from the driver (or passenger) of the vehicle. The control and processors and optical sensor(s) and acoustic microphone may all be disposed at or in the mirror assembly, such that the voice acquisition system is integrated into the mirror assembly and provides the vocal signal determination output to a vehicle system (such as an infotainment system or telematics system or navigation system or the like) that may also be at the mirror assembly or may be elsewhere in the vehicle.

In addition to the enhanced voice acquisition by use of the optical sensor combined with a microphone, the system of the present invention can be further improved in order to provide additional features and information to the vehicle. For example, the enhanced voice signal can be used for automatic speaker recognition and/or biometric authentication of the driver. Optionally, the optical sensor could also be used for biometric monitoring of the driver, and may monitor biometric signals such as heart rate, respiration rate, or larger scale movements of the head and face. These biometric signals can also be sensed and processed to help indicate the drowsiness or attentiveness of the driver of the vehicle.

While the interior rearview mirror assembly is the preferred location for the optical sensor, it may also or otherwise be positioned at or in other locations throughout the vehicle for sensing the driver and/or vehicle occupants other than the driver. For example, an optical sensor of the system of the present invention may be disposed at or in one or more interior door handles of the vehicle and/or one or more overhead grab handles of the vehicle and/or any other suitable location that provides a sensing field that encompasses the driver's head region (and/or passenger's head region or the like).

The mirror assembly 16 includes a casing and a reflective element positioned at a front portion of the casing. The mirror assembly is configured to be adjustably mounted to an interior portion of a vehicle (such as to an interior or in-cabin surface of a vehicle windshield or a headliner of a vehicle or the like) via a mounting structure or mounting configuration or assembly. The mirror reflective element may comprise a variable reflectance mirror reflective element that varies its reflectance responsive to electrical current applied to conductive coatings or layers of the reflective element, or the mirror reflective element may comprise a prismatic mirror reflective element.

The mirror casing may include a bezel portion that circumscribes a perimeter region of the front surface of the reflective element, or the perimeter region of the front surface of the reflective element may be exposed (such as by utilizing aspects of the mirror reflective elements described in International Publication Nos. WO 2010/124064; WO 2011/044312; WO 2012/051500; WO 2013/071070 and/or WO 2013/126719, which are hereby incorporated herein by reference in their entireties).

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled perimeter edge around the reflective element and with no overlap onto the front surface of the reflective element (such as by utilizing aspects of the mirror assemblies described in U.S. Pat. Nos. 7,255,451; 7,289,037; 7,360,932; 8,049,640; 8,277,059 and/or 8,529,108, or such as a mirror assembly having a rear substrate of an electro-optic or electrochromic reflective element nested in the mirror casing, and with the front substrate having curved or beveled perimeter edges, or such as a mirror assembly having a prismatic reflective element that is disposed at an outer perimeter edge of the mirror casing and with the prismatic substrate having curved or beveled perimeter edges, such as described in U.S. Des. Pat. Nos. D633,423; D633,019; D638,761 and/or D647,017, and/or International Publication Nos. WO 2010/124064; WO 2011/044312; WO 2012/051500; WO 2013/071070 and/or WO 2013/126719, which are hereby incorporated herein by reference in their entireties (and with electrochromic and prismatic mirrors of such construction are commercially available from the assignee of this application under the trade name INFINITY™ mirror).

As discussed above, the mirror assembly may comprise an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic mirror assembly may utilize the principles disclosed in commonly assigned U.S. Pat. Nos. 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, which are hereby incorporated herein by reference in their entireties.

Although shown as an electrochromic mirror application, it is envisioned that the mirror assembly may comprise a prismatic reflective element, while remaining within the spirit and scope of the present invention. The prismatic mirror assembly may be mounted or attached at an interior portion of a vehicle (such as at an interior surface of a vehicle windshield) via the mounting means described above, and the reflective element may be toggled or flipped or adjusted between its daytime reflectivity position and its nighttime reflectivity position via any suitable toggle means, such as by utilizing aspects of the mirror assemblies described in U.S. Pat. Nos. 6,318,870 and/or 7,249,860, and/or U.S. Publication No. U.S.-2010-0085653, which are hereby incorporated herein by reference in their entireties. Optionally, for example, the interior rearview mirror assembly may comprise a prismatic mirror assembly, such as the types described in U.S. Pat. Nos. 7,420,756; 7,338,177; 7,289,037; 7,274,501; 7,255,451; 7,249,860; 6,318,870; 6,598,980; 5,327,288; 4,948,242; 4,826,289; 4,436,371 and/or 4,435,042, which are hereby incorporated herein by reference in their entireties.

The mirror assembly may include user actuatable inputs operable to control any of the accessories of or associated with the mirror assembly and/or an accessory module or the like. For example, the mirror assembly may include touch sensitive elements or touch sensors or proximity sensors, such as the types of touch sensitive elements described in U.S. Pat. Nos. 5,594,222; 6,001,486; 6,310,611; 6,320,282; 6,627,918; 7,224,324 and/or 7,253,723, and/or International Publication Nos. WO 2012/051500 and/or WO 2013/071070, which are hereby incorporated herein by reference in their entireties, or such as proximity sensors of the types described in U.S. Pat. Nos. 7,224,324; 7,249,860 and/or 7,446,924, and/or International Publication No. WO 2004/058540, which are hereby incorporated herein by reference in their entireties, or such as membrane type switches, such as described in U.S. Pat. No. 7,360,932, which is hereby incorporated herein by reference in its entirety, or such as detectors and the like, such as the types disclosed in U.S. Pat. Nos. 7,255,541; 6,504,531; 6,501,465; 6,492,980; 6,452,479; 6,437,258 and/or 6,369,804, which are hereby incorporated herein by reference in their entireties, and/or the like, while remaining within the spirit and scope of the present invention.

Optionally, the user inputs or buttons may comprise user inputs for a garage door opening system, such as a vehicle based garage door opening system of the types described in U.S. Pat. Nos. 6,396,408; 6,362,771; 7,023,322 and/or 5,798,688, which are hereby incorporated herein by reference in their entireties. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131,154; 5,255,442; 5,632,092; 5,798,688; 5,971,552; 5,924,212; 6,243,003; 6,278,377; 6,420,975; 6,477,464; 6,946,978; 7,308,341; 7,167,796; 7,004,593; 7,657,052 and/or 6,678,614, and/or U.S. Pat. Pub. No. U.S.-2006-0050018, which are all hereby incorporated herein by reference in their entireties.

Optionally, the mirror assembly may include one or more other displays, such as the types disclosed in U.S. Pat. Nos. 5,530,240 and/or 6,329,925, which are hereby incorporated herein by reference in their entireties, and/or display-on-demand transflective type displays, and/or video displays or display screens, such as the types disclosed in U.S. Pat. Nos. 8,890,955; 7,855;755; 7,338,177; 7,274,501; 7,255,451; 7,195,381; 7,184,190; 7,046,448; 5,668,663; 5,724,187; 5,530,240; 6,329,925; 6,690,268; 7,734,392; 7,370,983; 6,902,284; 6,428,172; 6,420,975; 5,416,313; 5,285,060; 5,193,029 and/or 4,793,690, and/or in U.S. Pat. Pub. Nos. U.S.-2006-0050018; U.S.-2009-0015736; U.S.-2009-0015736 and/or U.S.-2010-0097469, which are all hereby incorporated herein by reference in their entireties.

Optionally, the mirror assembly may include one or more other accessories at or within the mirror casing, such as one or more electrical or electronic devices or accessories, such as antennas, including global positioning system (GPS) or cellular phone antennas, such as disclosed in U.S. Pat. No. 5,971,552, a communication module, such as disclosed in U.S. Pat. No. 5,798,688, a blind spot detection system, such as disclosed in U.S. Pat. Nos. 5,929,786 and/or 5,786,772, transmitters and/or receivers, such as a garage door opener or the like, a digital network, such as described in U.S. Pat. No. 5,798,575, a high/low headlamp controller, such as disclosed in U.S. Pat. Nos. 5,796,094 and/or 5,715,093, a memory mirror system, such as disclosed in U.S. Pat. No. 5,796,176, a hands-free phone attachment, a video device for internal cabin surveillance and/or video telephone function, such as disclosed in U.S. Pat. Nos. 5,760,962 and/or 5,877,897, a remote keyless entry receiver, lights, such as map reading lights or one or more other lights or illumination sources, such as disclosed in U.S. Pat. Nos. 6,690,268; 5,938,321; 5,813,745; 5,820,245; 5,673,994; 5,649,756; 5,178,448; 5,671,996; 4,646,210; 4,733,336; 4,807,096; 6,042,253; 5,669,698; 7,195,381; 6,971,775 and/or 7,249,860, microphones, such as disclosed in U.S. Pat. Nos. 7,657,052; 6,243,003; 6,278,377 and/or 6,420,975, speakers, antennas, including global positioning system (GPS) or cellular phone antennas, such as disclosed in U.S. Pat. No. 5,971,552, a communication module, such as disclosed in U.S. Pat. No. 5,798,688, a voice recorder, a blind spot detection system, such as disclosed in U.S. Pat. Nos. 7,720,580; 7,038,577; 6,882,287; 5,929,786 and/or 5,786,772, transmitters and/or receivers, such as for a garage door opener or a vehicle door unlocking system or the like (such as a remote keyless entry system), a digital network, such as described in U.S. Pat. No. 5,798,575, a high/low headlamp controller, such as a camera-based headlamp control, such as disclosed in U.S. Pat. Nos. 5,796,094 and/or 5,715,093, a memory mirror system, such as disclosed in U.S. Pat. No. 5,796,176, a hands-free phone attachment, an imaging system or components or circuitry or display thereof, such as an imaging and/or display system of the types described in U.S. Pat. Nos. 7,400,435; 7,526,103; 6,690,268 and/or 6,847,487, and/or U.S. Pat. Pub. No. U.S.-2006-0125919, a video device for internal cabin surveillance (such as for sleep detection or driver drowsiness detection or the like) and/or video telephone function, such as disclosed in U.S. Pat. Nos. 5,760,962 and/or 5,877,897, a remote keyless entry receiver, a seat occupancy detector, a remote starter control, a yaw sensor, a clock, a carbon monoxide detector, status displays, such as displays that display a status of a door of the vehicle, a transmission selection (4wd/2wd or traction control (TCS) or the like), an antilock braking system, a road condition (that may warn the driver of icy road conditions) and/or the like, a trip computer, a tire pressure monitoring system (TPMS) receiver (such as described in U.S. Pat. Nos. 6,124,647; 6,294,989; 6,445,287; 6,472,979; 6,731,205 and/or 7,423,522, and/or an ONSTAR® system, a compass, such as disclosed in U.S. Pat. Nos. 5,924,212; 4,862,594; 4,937,945; 5,131,154; 5,255,442 and/or 5,632,092, and/or any other accessory or circuitry or the like (with all of the above-referenced patents and publications being commonly assigned and being hereby incorporated herein by reference in their entireties).

Changes and modifications in the specifically described embodiments may be carried out without departing from the principles of the present invention, which is intended to be limited only by the scope of the appended claims as interpreted according to the principles of patent law.

1. A voice acquisition system for a vehicle, said voice acquisition system comprising:
an optical sensor disposed at an interior portion of the vehicle and having a sensing field that encompasses a driver's head region in the vehicle cabin typically occupied by a driver's head;
an optical sensor processor for processing an output of said optical sensor to determine vibrations of the driver that are indicative of vocal signals emanating from the driver;
a microphone operable to receive audible signals from in the vehicle cabin;
a microphone processor for processing an output of said microphone; and
a control, wherein said control, responsive to processing of said output of said optical sensor by said optical sensor processor and processing of said output of said microphone by said microphone processor, isolates the driver's voice from other acoustic noise.

2. The voice acquisition system of claim 1, wherein said microphone is disposed at the interior portion of the vehicle.

3. The voice acquisition system of claim 2, wherein said optical sensor processor, said microphone processor and said control are disposed at the interior portion of the vehicle.

4. The voice acquisition system of claim 1, wherein said optical sensor, said optical sensor processor, said microphone and said microphone processor and said control are disposed at an interior rearview mirror assembly of the vehicle.

5. The voice acquisition system of claim 1, wherein said control comprises a vehicle-based control comprising said optical sensor processor and said microphone processor, and wherein said vehicle-based control receives said output of said microphone processor and said output of said optical sensor processor.

6. The voice acquisition system of claim 1, wherein said control, responsive to isolation of the driver's voice from other acoustic noise, is operable to determine the driver's spoken words.

7. The voice acquisition system of claim 6, wherein said control, responsive to determination of the driver's spoken words, controls a vehicle system.

8. The voice acquisition system of claim 6, wherein said control, responsive to determination of the driver's spoken words, generates an output to one of (i) an infotainment system of the vehicle, (ii) a navigation system of the vehicle and (iii) a telematics system of the vehicle.

9. The voice acquisition system of claim 1, wherein said optical sensor comprises a interferometer and wherein said optical sensor processor is operable to process data captured by said interferometer.

10. The voice acquisition system of claim 9, comprising a laser generator that emits a laser light beam toward a region where the driver's head and/or neck are expected to be.

11. The voice acquisition system of claim 10, comprising a camera having a field of view that encompasses the driver's head region, and wherein an aim of the laser generator is adjusted responsive to image processing of image data captured by said camera.

12. A voice acquisition system for a vehicle, said voice acquisition system comprising:
an optical sensor disposed at an interior portion of the vehicle and having a sensing field that encompasses a driver's head region in the vehicle cabin typically occupied by a driver's head;
an optical sensor processor for processing an output of said optical sensor to determine vibrations of the driver that are indicative of vocal signals emanating from the driver;
a camera having a field of view that encompasses the driver's head region, and wherein an aim of the optical sensor is adjusted responsive to image processing of image data captured by said camera;
a microphone operable to receive audible signals from in the vehicle cabin;
a microphone processor for processing an output of said microphone; and
a control, wherein said control, responsive to processing of said output of said optical sensor by said optical sensor processor and processing of said output of said microphone by said microphone processor, isolates the driver's voice from other acoustic noise.

13. The voice acquisition system of claim 12, wherein said microphone, said optical sensor processor, said microphone processor and said control are disposed at the interior portion of the vehicle.

14. The voice acquisition system of claim 12, wherein said optical sensor, said optical sensor processor, said microphone and said microphone processor and said control are disposed at an interior rearview mirror assembly of the vehicle.

15. The voice acquisition system of claim 12, wherein said control, responsive to isolation of the driver's voice from other acoustic noise, is operable to determine the driver's spoken words, and wherein said control, responsive to determination of the driver's spoken words, controls a vehicle system.

16. A voice acquisition system for a vehicle, said voice acquisition system comprising:
an optical sensor comprising an interferometer disposed at an interior portion of the vehicle and having a sensing field that encompasses a driver's head region in the vehicle cabin typically occupied by a driver's head;
an optical sensor processor for processing an output of said interferometer to determine vibrations of the driver that are indicative of vocal signals emanating from the driver;
wherein a laser generator that emits a laser light beam toward the driver's head region, and wherein said interferometer senses the emitted laser light beam at the driver's head region;
a camera having a field of view that encompasses the driver's head region, and wherein an aim of the laser generator is adjusted responsive to image processing of image data captured by said camera;
a microphone operable to receive audible signals from in the vehicle cabin;
a microphone processor for processing an output of said microphone; and
a control, wherein said control, responsive to processing of said output of said interferometer by said optical sensor processor and processing of said output of said microphone by said microphone processor, isolates the driver's voice from other acoustic noise.

17. The voice acquisition system of claim 16, wherein said microphone, said optical sensor processor, said microphone processor and said control are disposed at the interior portion of the vehicle.

18. The voice acquisition system of claim 16, wherein said interferometer, said optical sensor processor, said microphone and said microphone processor and said control are disposed at an interior rearview mirror assembly of the vehicle.

19. The voice acquisition system of claim 16, wherein said control comprises a vehicle-based control comprising said optical sensor processor and said microphone processor, and wherein said vehicle-based control receives said output of said microphone processor and said output of said optical sensor processor.

20. The voice acquisition system of claim 16, wherein said control, responsive to isolation of the driver's voice from other acoustic noise, is operable to determine the driver's spoken words, and wherein said control, responsive to determination of the driver's spoken words, controls a vehicle system.
